(19) United States
(12) Patent Application Publication
(10) Pub. No.: US 2003/0024329 A1
(43) Pub. Date: Feb. 6, 2003

(54) Method and apparatus for sampling liquid from biomass

(76) Inventors: Kenneth W. McMillin, Baton Rouge, LA (US); Jerry Mitchell, Livingston, TX (US); Brian S. Smith, Cumming, GA (US)

Correspondence Address: Gregory M. Luck, Sankey & Luck, L.L.P., 6200 Chase Tower, 600 Travis, Houston, TX, 77002, US

(21) Appl. No.: 09/923,004

(22) Filed: Aug. 3, 2001

(51) Int. Cl. G01N 1/10; G01N 1/22

(52) U.S. Cl. 73/863.23; 73/864.73; 435/30

(57) ABSTRACT

A process of sampling liquid elucidate from comestibles comprising the steps of disposing a receptacle in fluid communication with the elucidate from the comestibles, transporting the elucidate in the receptacle, dispensing the sample of elucidate from the receptacle, and analyzing the sample. A device for sampling liquid elucidate from comestibles includes a fluid flow conduit having two ends where the first end is designed to communicate with the elucidate and the second end is disposed in fluid communication with the sampling means.

### FIELD OF THE INVENTION

The present invention generally relates to the processing of comestibles. More specifically, the present invention relates to a method and apparatus to sample a liquid elucidate generated by a biomass for purposes of evaluating a contamination profile.

### BACKGROUND OF THE INVENTION

It is commonly recognized that microorganisms contaminate comestibles or foodstuffs, thereby causing them to spoil. Microorganisms may be transported through the atmosphere and are found in the environment. Microorganisms may also be transported through physical contact with utensils used to process or analyze a source of contaminants. Microorganisms may also be present in diseased specimens which comprise the foodstuff that are contaminated during normal slaughter and processing operations.

During collection, some comestibles, such as biomass comestibles, are stored in large containers as they await processing. These comestibles may comprise foodstuffs such as vegetables or food additives. Alternatively, these comestibles may include various meat cuts obtained during the slaughtering process.

Storage of perishable products, and especially meat cuts, in this fashion, however, creates the risk of contamination from any one contaminated portion since the liquid elucidate carries the contaminants to all components in the container. It is therefore necessary to test the biomass on a periodic basis to evaluate the presence of potential contaminants. Such testing is preferably conducted by way of periodic sampling where the biomass is accompanied by a elucidate, which is the case in the instance of meat cuts. It is preferable to perform this sampling from the liquid elucidate found at the bottom of the container. Bottom sampling is desired since contaminants of any portion of the biomass will usually be reflected in the elucidate found in the lower regions of the container. Microbial profile of liquid elucidate is highly related to the microbial profile of the biomass.

When comestibles are stored in a container, however, sampling of the bottom-most portion has been difficult due to its inaccessibility from the top opening in the container. This difficulty is exacerbated when the biomass comprises large beef cuts of irregular sizes and shapes.

A variety of techniques have been developed to sample a biomass to check for contaminants. One solution has been to drill into the comestibles so that a sample can be obtained from the bottom. However, this sampling method often retrieves an unrepresentative sample of the whole, and may also contribute to subsequent contamination of the comestibles due to the contaminated drill bit.

Still other techniques have included providing a valve on the bottom of the container. Such a valve, however, requires a rigid cleaning program since any contamination introduced to the valve must be thoroughly removed in order to avoid contaminating subsequent samples, as well as the hazard of reintroducing contaminants.

### SUMMARY OF THE INVENTION

The present invention presents a number of advantages over prior art systems and devices for sampling of a biomass.

The present invention has application to a biomass situated in a container in which a liquid elucidate from said biomass is collected in the bottom of the container. A general embodiment of the invention comprises an elongate body adapted for being manipulated between the individual components of the biomass so as to reach the pool of elucidate at the bottom of the container and sampling means adapted to be lowered within the end of the body immersed in the elucidate, where the sampling means contains means to retrieve the sample through the body for evaluation and testing.

The present invention achieves a number of advantages over the prior art. One such advantage is the ability to obtain and remove a sample of a biomass elucidate while the biomass remains in a container. A second advantage is the ability to obtain samples without the portent of contamination or re-contamination.

Still other advantages of the invention will become obvious in light of the figures and the detailed description of the preferred embodiment.

### BRIEF DESCRIPTION OF THE DRAWINGS

FIG. 1 is a partially cutaway view of a prior art device.

FIG. 2 is a partially cutaway view of one embodiment of the present invention as it may be used for sampling a liquid elucidate from a biomass.

FIG. 3 is a systemic, diagrammatic view of an alternate embodiment of the device of FIG. 2.

FIG. 4 is a detail view of the probe ends of the embodiment illustrated in FIG. 3.

FIG. 5 is a detail view of an alternate embodiment of the present invention.

FIG. 6 is a perspective view of another prior art embodiment of the invention.

### DETAILED DESCRIPTION OF PREFERRED EMBODIMENTS

FIG. 1 illustrates one prior art system for sampling a biomass to evaluate the presence of potential contaminants. By reference to FIG. 1 there is illustrated a container 2 which contains an amalgamation of meat portions 4 which are sequentially deposited in said container 2 during the slaughtering, fabrication, and processing operations. In such a fashion, the portions 4 situated at the bottom-most portion of container 2 will have been deposited in container prior to those cuts or pieces deposited in the uppermost portion of the container.

In FIG. 1, a modified drill bit or corer 8 is used to drill through the meat portions 4 to obtain what is hoped to be a representative sample for purposes of review and evaluation. This process fails for a number of reasons. One failure of such a process lies in the potential for contamination. Any contaminated portion through which the bit 8 passes presents the opportunity to contaminate other meat portions which come in contact with said bit 8. For such reasons, the sample taken in the middle or bottom-most portion of the biomass may in reality only reflect the contamination of the uppermost portion, since all such contamination s is carried on bit 8. In such a fashion, such a procedure fails since it has no way of obtaining a discrete sample which is uncontaminated by meat portions 4 elsewhere disposed in container 2. Finally, such a procedure is cumbersome and potentially dangerous due to the different textures presented in a biomass which may include meat, bone and fat, all of which may possess different torgidity.

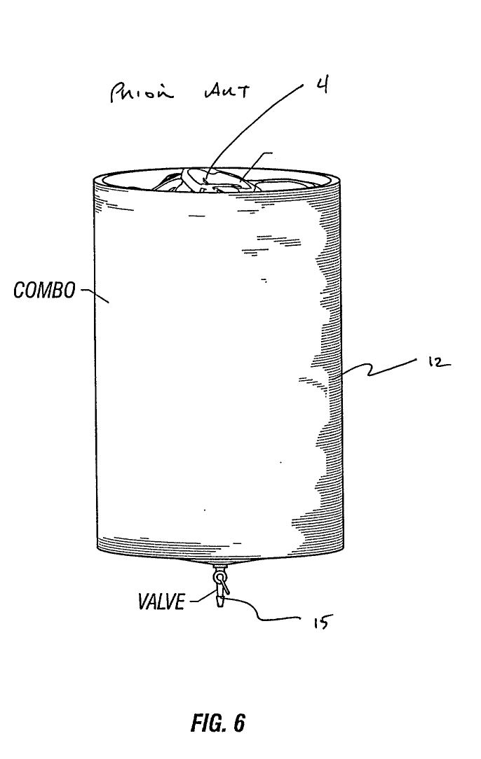

A second prior art technique for sampling is illustrated in FIG. 6 in which is again illustrated a container 12 in which are disposed an undifferentiated collection of meat portions 4. In this example of the prior art, a sample of the elucidate may be taken through a valve 15 situated about the bottom of container 12, as illustrated.

Using the system illustrated in FIG. 6, a sample may be taken of the elucidate coming into contact with the valve 15 through percolation at the bottom-most portion of container 12. Disadvantages of this technique reside in the necessity to have an expensive valve apparatus on each container before the decision is made to sample the biomass. Moreover, any contaminants coming into contact with valve 15 thereafter serve to contaminate any other elucidate passing therethrough unless the valve is cleaned and sterilized.

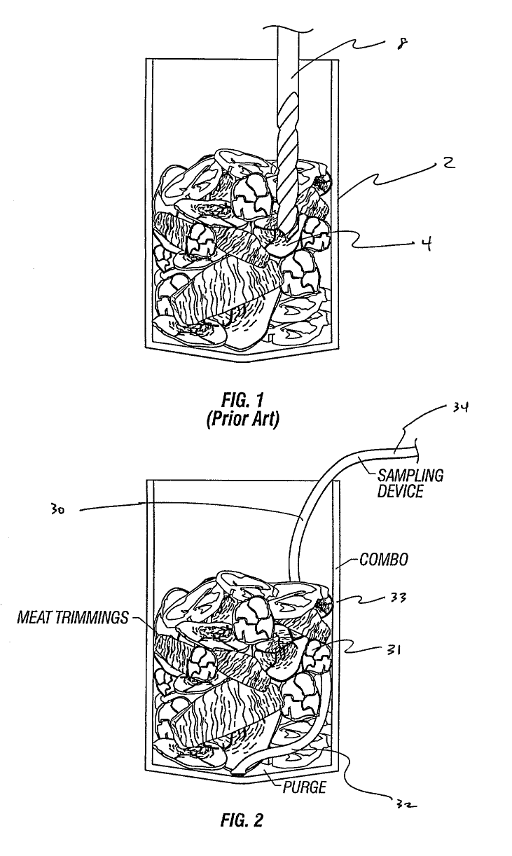

Various embodiments of the present invention may be seen by reference to FIGS. 2-5. By reference to FIGS. 2-4, there is illustrated a first embodiment which comprises an elongate body 30 defining a first end 32 and a second end 34, where said first end 32 is adapted to be manipulated through and around the various meat cuts 31 as situated in a container 33 to a desired sampling point, e.g. the middle or bottom of the container.

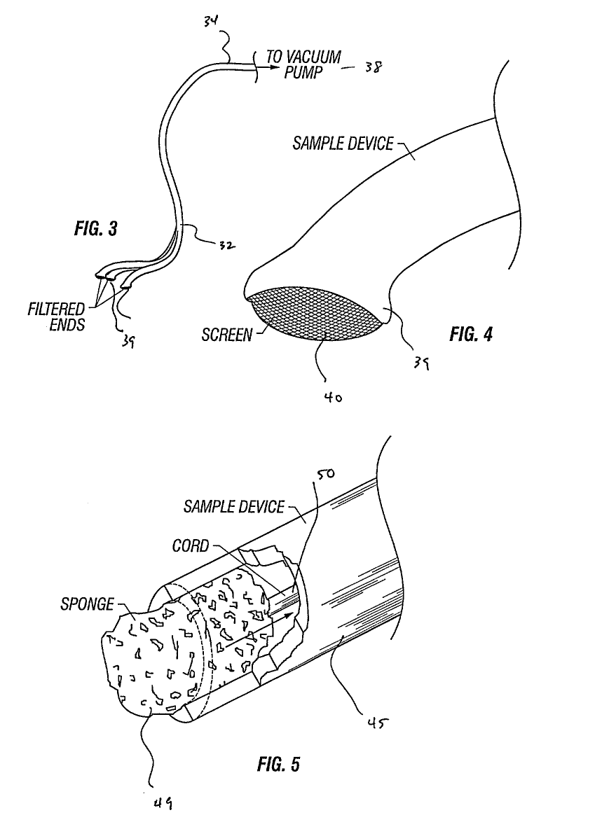

Body 30 defines a fluid flow passageway therethrough second end 34 is adapted to be secured to a vacuum pump 38 (not shown), the combination allowing a representative elucidate sample to be removed from the biomass. By reference to FIGS. 3-4, the first end 32 may define one or more fluid flow inlets 39, where each inlet is coupled to the body 30. In such a fashion, a variety of samples may simultaneously or sequentially be obtained.

To prevent the individual withdrawal of pieces of the biomass, the first end 32 of body 30 may be provided with a screen 40 or other means to filter the elucidate. A trap (not shown) may be included between the second end 34 and pump 38 to obtain and hold the sample.

Still another embodiment of the present invention is shown in FIG. 5 in which is illustrated a body 40 defining a fluid flow passageway 42 therethrough. Consistent with the embodiments illustrated in FIGS. 2-4, body 40 defines a first end 45 and a second end (not shown). A sampling device 49, e.g. a sponge, is disposed in first end 45 such that it will collect elucidate when first end 45 is desirably positioned in the elucidate. Sampling device 49 may be withdrawn into passageway 42 via cord 50 and body thereafter withdrawn from the biomass for purposes of testing. In such a fashion, contamination collected on the sampling device 49 will not be brought into contact with uncontaminated portions of the biomass. Alternatively, sampling device 49 may be withdrawn and a second sampling device positioned to take its place as the first end 45 of body 40 is selectively positioned through the biomass.

Although particular detailed embodiments of the system and method have been described herein, it should be understood that the invention is not restricted to the details of the preferred embodiment. Many changes in design, composition, configuration and dimensions are possible without departing from the spirit and scope of the instant invention.

What is claimed is:

1. A system to enable the selective sampling of a liquid elucidate generated from a biomass, comprising a tubular body member defining a first and a second end coupled by a fluid flow passageway there through, where said first end is adapted to be manipulated through said biomass to a selected area within said elucidate, and said second end is adapted to be operatively engaged with a vacuum means such that a sample of said elucidate may be withdrawn through said body for collection at said second end.

2. The system of claim 1 further including filtering means coupled to the first end of said body.

3. The system of claim 1 where said first end includes several terminal ends all of which are disposed in fluid communication with said fluid flow passageway.

4. The system of claim 1 where said body member is made from a plastic extrusion or natural rubber.

5. The system of claim 1 further including a trap to hold contaminants withdrawn through said fluid passageway.

6. The system of claim 1 further including a container in which the biomass is disposed where further the tubular body member is predisposed within said container prior to deposition of the biomass.

7. The system of claim 6 where said tubular body is inserted in a preexisting channel or groove formal in the bottom or side of the container.

8. A system to sample a fluid derived from biomass comprising:
(a) a conduit defining a first and second end where said first end is disposed in flow communication with the fluid;
(b) a sampling member capable of retaining a selected quantity of said fluid disposed proximate to the first end; and
(c) means to withdraw said sampling member through the said conduit to said second end.

9. The system of claim 6 where said sampling member comprises an absorbent body.

10. The system of claim 7 where said withdrawal means includes a cord attached to said absorbent body.

11. A method of sampling a liquid elucidate derived from a containerized biomass comprising the steps of:
(a) inserting a tube having a proximal and distal end through the biomass so as to establish a fluid path to the elucidate;
(b) withdrawing a sample of said elucidate through said tube; and
(c) analyzing the bacterial content of the analyzed sample.

12. The method of claim 9 wherein said elucidate is withdrawn through the tube via a vacuum pump.

13. The method of claim 9 further including the step of filtering the sample.

14. The method of claim 9 further including the step of trapping the elucidate sample in a containing means located about the distal end and withdrawing the containing means from said distal end to said proximal end.

15. The of method of claim 12 where said containing means comprises an absorbent body.

16. A system to enable the selective sampling of liquid elucidate generated from a biomass, comprising a container to hold the biomass where the container includes a selectively porous liner and a body member defining a first and second end where said body member forms a portion of the liner such that elucidate coming into content with the front end of said body member may be withdrawn through said second end.
